(19) United States
(12) Patent Application Publication
(10) Pub. No.: US 2026/0082267 A1
(43) Pub. Date: Mar. 19, 2026

(54) SYSTEM AND METHOD FOR TRANSIENT ROAMING AND SLICING IN REAL-TIME DISTRIBUTED MOBILITY MANAGEMENT

(71) Applicant: AT&T Intellectual Property I, L.P., Atlanta, GA (US)

(72) Inventors: Joseph Soryal, Glendale, NY (US); Howard L. Lang, Wayside, NJ (US); Neel Patel, Short Hills, NJ (US); Mario Manuel Jardon, Pembroke Pines, FL (US); Venson Shaw, Kirkland, WA (US)

(73) Assignee: AT&T Intellectual Property I, L.P., Atlanta, GA (US)

(21) Appl. No.: 18/889,570

(22) Filed: Sep. 19, 2024

(51) Int. Cl. H04W 28/02; H04W 28/24; H04W 28/26; H04W 72/543

(52) U.S. Cl. CPC H04W 28/0226; H04W 28/24; H04W 28/26; H04W 72/543

(57) ABSTRACT

Aspects of the subject disclosure may include, for example, a device, having: a processing system including a processor; and a memory that stores executable instructions that, when executed by the processing system, facilitate performance of operations of: determining a predicted path of travel of a mobile device using a first network for data communications; identifying a second network providing communication services in an area that would be entered by the predicted path; synchronizing communication requirements of a communication session of an application on the mobile device with the second network; and establishing the communication session between the mobile device and the second network for the application. Other embodiments are disclosed.

### FIELD OF THE DISCLOSURE

The subject disclosure relates to a system and method for transient roaming and slicing in real-time distributed mobility management.

### BACKGROUND

Transient roaming refers to a temporary roaming scenario where a mobile user connects to a public land mobile network (PLMN) for a brief period. This can occur when a mobile device is traveling and briefly enters the coverage area of a network operator different from the carrier that normally provides service to the mobile device. The mobile device connects to the visited PLMN (VPLMN) only for a short duration, often just passing through the area of coverage. Transient roaming ensures that the mobile device maintains service continuity without interruptions, even when moving between different network operators. Often, the carrier's home network (HPLMN) handles billing and authentication, ensuring that the mobile device is correctly identified and charged for the services used during the transient roaming period.

A core network plays a crucial role in supporting transient roaming by ensuring seamless connectivity and service continuity for users who temporarily connect to a VPLMN. In fourth generation (4G) networks, roaming is facilitated through the Evolved Packet System (EPS), which includes the Evolved Packet Core (EPC) and the Evolved Universal Terrestrial Radio Access Network (E-UTRAN). In addition to the HPLMN and VPLMN, key components include a Mobility Management Entity (MME) that manages user mobility and session states, a Serving Gateway (SGW) and Packet Data Network Gateway (PGW) that handle data traffic routing and forwarding. When a user roams, the MME in the VPLMN communicates with the HPLMN to authenticate the user and establish a data session, allowing seamless data and voice services.

In fifth generation (5G) networks, roaming is more advanced and can be categorized into two main types: Non-Standalone (NSA) and Standalone (SA) roaming. NSA roaming utilizes existing 4G infrastructure for control signaling while providing 5G data services. The 5G data traffic is tunneled through the 4G network. SA roaming operates entirely on 5G infrastructure, offering enhanced capabilities and performance. Key components in 5G roaming include: the 5G core, which is the central part of the 5G network that manages all network functions, an Access and Mobility Management Function (AMF), which manages user mobility and session states, a User Plane Function (UPF) that handles data traffic routing and forwarding, and a Security Edge Protection Proxy (SEPP) that ensures secure communication between different network operators. Both 4G and 5G roaming rely on agreements between network operators to ensure users can access services seamlessly while traveling. The transition from 4G to 5G roaming involves integrating new network functions and protocols to support the enhanced capabilities of 5G.

Further, a key feature in fifth generation (5G) networks called network slicing allows operators to create multiple virtual networks on a shared physical infrastructure. Each slice can be tailored to meet specific requirements, such as latency, bandwidth, and security. During transient roaming, network slicing ensures that users receive consistent and optimized service quality, even when temporarily connecting to a VPLMN. The HPLMN and the VPLMN coordinate to maintain the service slice used by the mobile device. The core network of the HPLMN transfers slice-specific policies and configurations to the VPLMN. For example, the device's service slice (e.g., for high-speed internet) is identified by the HPLMN and replicated in the VPLMN. Different slices can be allocated for numerous services to the device (e.g., Internet of Things (IoT), enhanced mobile broadband, ultra-dependable, low-latency communications). This ensures that the mobile device service quality remains consistent, regardless of which network that the mobile device is currently connected to. Network slicing allows dynamic allocation of resources based on the current location and service requirements. This ensures that transient roaming users receive the necessary resources without impacting the overall network performance. Each slice operates independently, providing enhanced security and isolation, which is crucial during roaming, as it ensures that the data and services are protected from potential threats in the visited network. This seamless integration of network slicing during transient roaming ensures that users experience consistent and high-quality service, regardless of their location.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system for transient roaming and slicing in real-time distributed mobility management functioning within the communication network of FIG. 1 in accordance with various aspects described herein.

FIG. 2B depicts an illustrative embodiment of a method in accordance with various aspects described herein.

FIG. 2C is a block diagram illustrating an example, non-limiting embodiment of a system for transient roaming and slicing for voice and text messaging functioning within the communication network of FIG. 1 in accordance with various aspects described herein.

FIG. 2D is a block diagram illustrating an example, non-limiting embodiment of a system preparing for handover during transient roaming for voice and text messaging functioning within the communication network of FIG. 1 in accordance with various aspects described herein.

FIG. 2E is a block diagram illustrating an example, non-limiting embodiment of a handover during transient roaming for voice and text messaging functioning within the communication network of FIG. 1 in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for managing transient roaming of mobile devices between carrier networks. Other embodiments are described in the subject disclosure.

One or more aspects of the subject disclosure include a device, having: a processing system including a processor; and a memory that stores executable instructions that, when executed by the processing system, facilitate performance of operations of: determining a predicted path of travel of a mobile device using a first network for data communications; identifying a second network providing communication services in an area that would be entered by the predicted path; synchronizing communication requirements of a communication session of an application on the mobile device with the second network; and establishing the communication session between the mobile device and the second network for the application.

One or more aspects of the subject disclosure include a non-transitory machine-readable medium, comprising executable instructions that, when executed by a processing system including a processor, facilitate performance of operations, such as: identifying a second network providing communication services in an area that a mobile device is predicted to enter, wherein the mobile device uses communication services from a first network for data communications; sending communication requirements of a communication session of an application on the mobile device to core elements of the second network; and establishing the communication session between the mobile device and the second network for the application.

One or more aspects of the subject disclosure include a method of: identifying, by a processing system including a processor, a second network providing communication services in an area that a mobile device using the communication services of a first network is predicted to enter; synchronizing, by the processing system, communication requirements of a communication session for an application on the mobile device between core elements of the first network and the second network, wherein the core elements include a policy control function, a session management function and a user plane function, wherein the communication requirements include a slice identifier, a data network name, a session and service continuity mode for the session, or a combination thereof; and requesting, by the processing system, the second network to establish the communication session between the mobile device and the second network for the application.

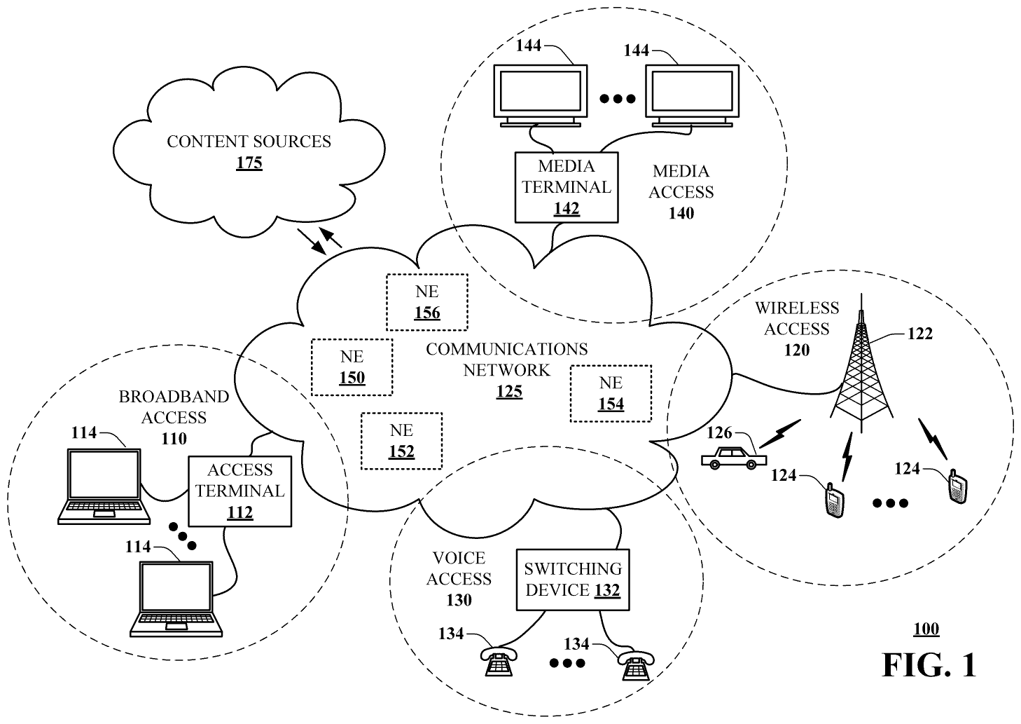

Referring now to FIG. 1, a block diagram is shown illustrating an example, non-limiting embodiment of a system 100 in accordance with various aspects described herein. For example, system 100 can facilitate in whole or in part predicting a travel path for a mobile device; identifying network(s) that can provide communication services along the predicted path; synchronizing communication requirements of application(s) on the mobile device; and establishing a communication session between the mobile device and new network(s). In particular, a communications network 125 is presented for providing broadband access 110 to a plurality of data terminals 114 via access terminal 112, wireless access 120 to a plurality of mobile devices 124 and an autonomous vehicle (AV 126) via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a fourth generation (4G), 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

AV 126 and other semi-autonomous vehicles, including cars and heavy trucks, need communication channels to a backend server in the core network and/or other vehicles. Although the majority of the decision-making processes will reside on-board, in certain events where the on-board device cannot act, the vehicle needs to reach out to a backend server. If communications between the autonomous vehicle and the backend server are cut off, even for a few seconds, this could create a dangerous situation.

What is needed is a system for transient roaming of mobile devices, such as autonomous vehicles, that can distinguish between “slow” data, where a higher latency of communications is acceptable (i.e., a change in weather conditions miles ahead) versus “fast”data, where an ultra-low latency may be required (i.e., remote driving updates). The system must always ensure that there is a communication channel between the vehicle and the backend server (and/or other vehicles).

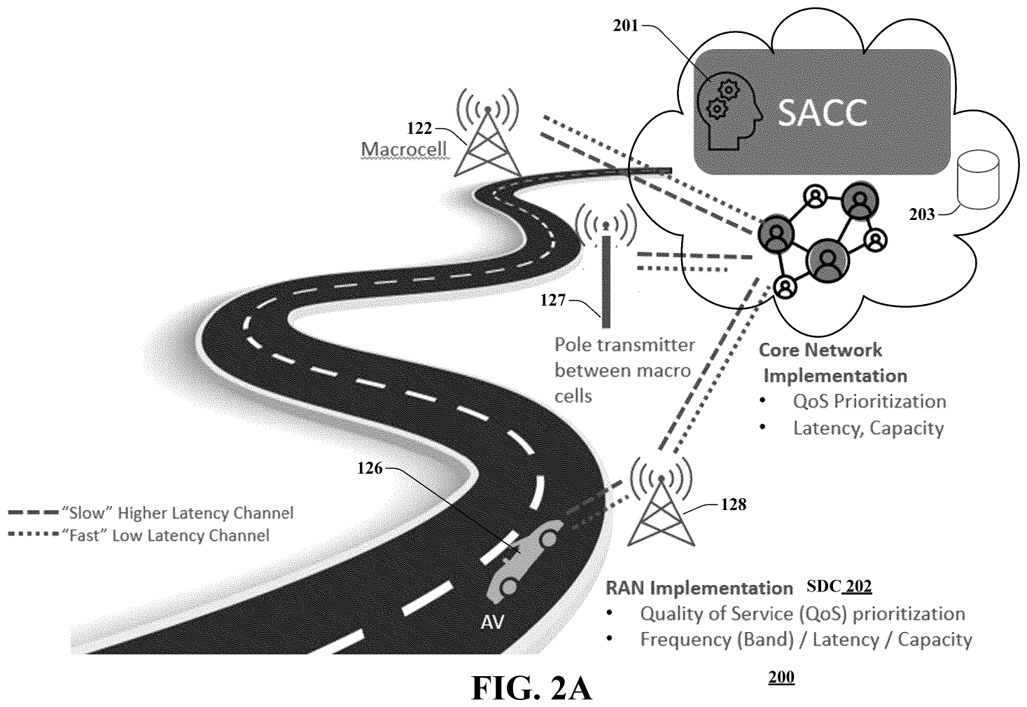

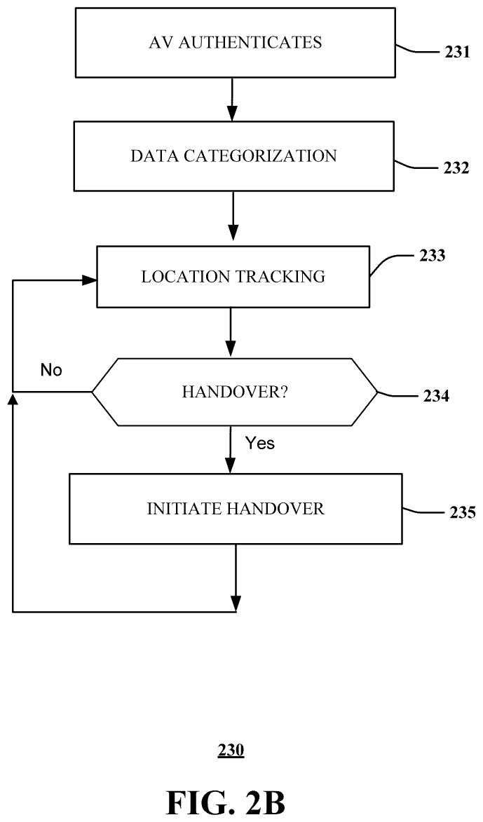

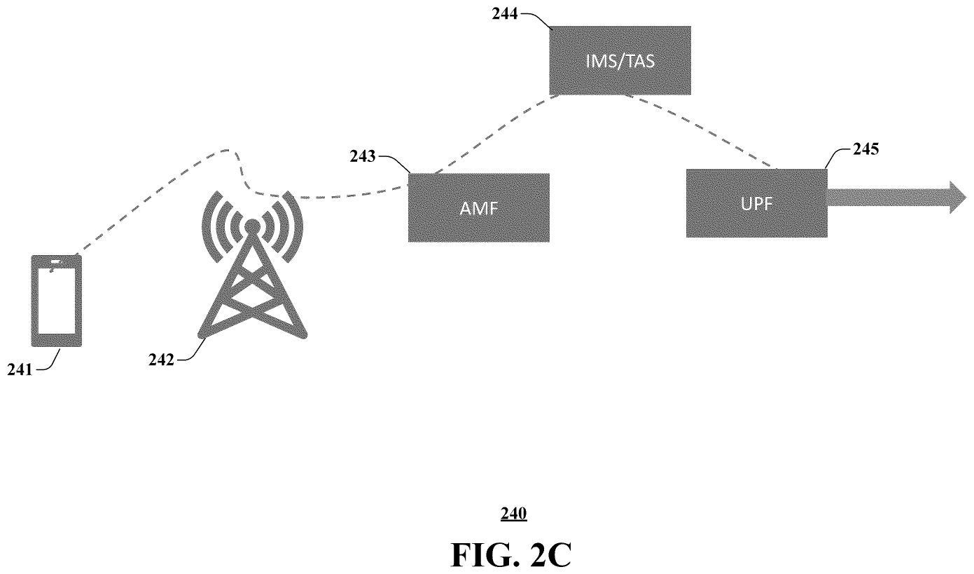

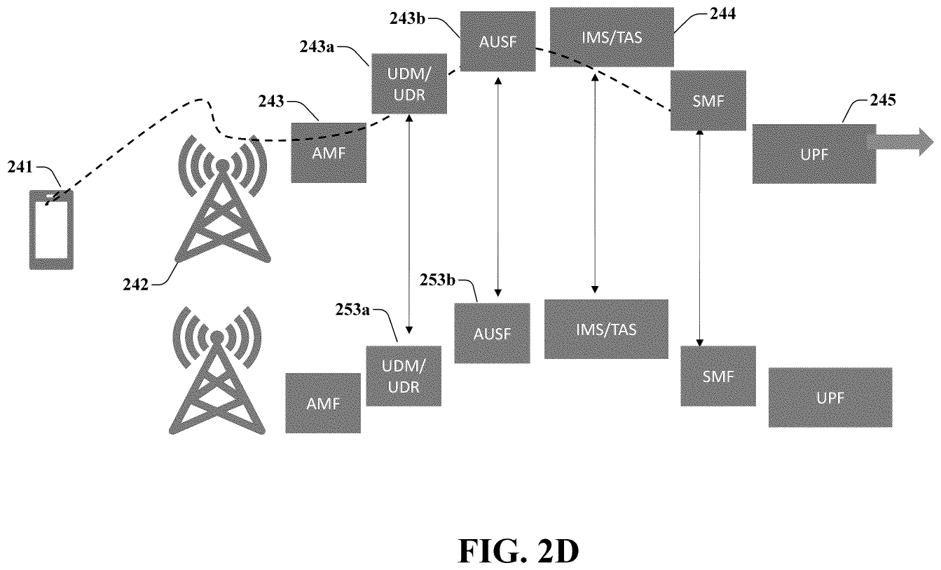

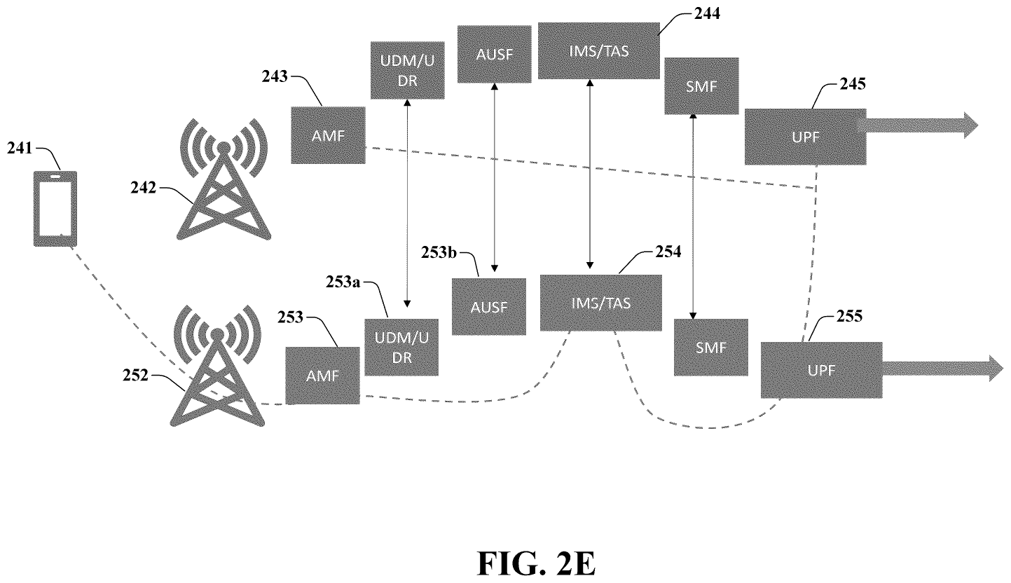

FIG. 2A is a block diagram illustrating an example, non-limiting embodiment of a system for transient roaming and slicing in real-time distributed mobility management functioning within the communication network of FIG. 1 in accordance with various aspects described herein. As shown in FIG. 2A, system 200 comprises a sensitive application coverage continuity embedded process module (SACC 201) and a software defined component (SDC 202) in the radio access portion of an autonomous vehicle (AV 126). System 200 is applicable to autonomous vehicles, or any other IoT device that may require ultra-low latency and high reliability Quality of Service (QoS).

In an embodiment, system 200 is a distributed system where SACC 201 is a mobility management entity (MME) of a 4G network, an access management function (AMF) of a 5G network, or the corresponding functionality of subsequent next generation (NG) networks. SACC 201 functions in the core network, while SDC 202 is embedded in the controller board of AV 126. When AV 126 communicates with an operator network through a base station or access point 122, a pole transmitter 127 between macro cells, or even a Wi-Fi access point 128, and comes in contact with an MME/AMF of a VPLMN, SACC 201 and SDC 202 are connected to accomplish mission critical functions. For example, SDC 202 collects and distributes local data pertaining to AV 126's operating conditions, road conditions, weather, etc. SDC 202 uses an API for backend servers in the core network to provide vehicle location, possibly approximated by serving cell site location. In turn, the backend servers may use location data to assign the session to the most desirable server. SDC 202 polls the servers periodically for availability and may re-route sessions to a different backend server if SDC 202 loses contact with the current server.

SACC 201 considers a balance between reliability and ultra-low latency versus high latency based on the communication requirements of each application (i.e., Transportation, Safety-Critical, Infotainment, etc.) implemented by AV 126. In an embodiment, SACC 201 is aware of the location, speed, direction of travel, surrounding traffic density, and road conditions of AV 126. Further, AV 126 detects wireless coverage level experienced by AV 126 for each operator's network, as well as the wireless coverage level available in the roadway ahead of AV 126. Further, SACC 201 gathers information concerning the functional requirements of the AV 126 (e.g., is it an emergency vehicle with patient aboard, police vehicle, etc.). In an embodiment, SACC 201 manages SDC 202 to adjust the radio spectrum for reception and transmission of radio signals, the QoS for the carrier band currently used, as well as the available carrier bands on the roadway ahead. In an embodiment, SACC 201 controls whether specific dedicated radio bands are used (i.e., 5.9 GHz vehicle-to-everything spectrum). SDC 202 reconfigures the radio unit of AV 126 to adjust for an available network operator's spectrum present in a geographical area. Various characteristics of the mobile radio unit, such as signal strength, bandwidth, and QoS prioritization are considered.

In an embodiment, SACC 201 work in conjunction with session and service continuity (SSC) Mode 3 in the 5G Core. The wireless operator will provision an SSC mode selection policy (SSCMSP) to SDC 202 as part of the user equipment (UE) route selection policy (URSP) rule from the policy control function (PCF). The mobile device shall use the SSCMSP to determine the type of session and service continuity mode associated with an application or group of applications for the mobile device. A rule would contain the slice identifier (slice Id), data network name (DNN) and SSC mode for the session. The system would preferably use SSC Mode 3 as described in 3GPP 23.501 and 23.502. With SSC mode 3, the network ensures that the UE suffers no loss of connectivity. The system establishes a connection through a new packet data unit (PDU) Session Anchor point before the previous connection is terminated (make before break). SACC 201 communicates the need to relocate the session to the current SMF based on factors such as latency or geographic location. This will allow SACC 201 to maintain the lowest latency possible between AV 126 and the SMF and UPF in the 5G core network.

In an embodiment, SACC 201 uses artificial intelligence (AI) to anticipate the radio spectrum available in the roadway ahead. The AI shall consider factors such as the communication priority, bandwidth requirements, number of vehicles, radio signal strength, radio bands, whether an emergency is observed through, for example, CCTV cameras or a change in traffic patterns to determine favorable radio communication parameters for AV 126.

In an embodiment, SACC 201 and others like it connect to a machine learning (ML) master repository (MR 203) that builds a knowledge base from the plurality of SACC instances. MR 203 creates generic profiles for autonomous vehicles, based on features including: vehicle structure, weight, top speed, age, acceleration, autonomous driver version and features, profiles for the environment including a geometry of the road in a particular segment, weather conditions, existing and predicted traffic conditions, and profiles for the networks including VPLMN, priority, network application type, priority, congestion (current & predicted), etc. SACC 201 uses the profiles from MR 203 to create different priorities to provide communications to AV 126 based on the profiles above to prioritize bandwidth and QoS for each application of AV 126.

FIG. 2B depicts an illustrative embodiment of a method in accordance with various aspects described herein. As shown in FIG. 2B, method 230 begins at step 231 where an autonomous vehicle (AV) authenticates with an HPLMN. When the AV starts to move and connects to the home network, the AV will reach out to the 5G core, which will trigger PCF profile read. A transponder of the AV has a unique cryptographical signature that is provided to a PCF of the core network of the HPLMN. The PCF also stores priority access and fast roaming arrangements for the AV. Next in step 232, information processes of the AV are categorized for handling by the system. The system categorizes the data processes as either a “slow” process that can tolerate a higher latency and thus use a high latency channel, or as a “fast” process that requires a lower latency channel.

The PCF will connect with the AMF (MME in 4G), which in turn invokes a SACC function in the core network. In step 233, the SACC function tracks the movement of the AV and predicts a path where the AV will travel. The SACC determines a level of coverage by available networks of other carriers for potential paths via overlaying the paths and road maps. The SACC reserves resources with the carrier that has the best coverage in each segment along the path meeting the requirements for the AV. In an embodiment, the SACC establishes several routing paths through the area travelled by the AV including roaming network hosts for the AV.

In step 234, the SACC checks whether the AV needs to switch communication connections from one network to another. If the AV does not need to switch, then the process continues at step 233. But if the AV must switch, then in step 235, the system initiates a handover from one network to another. The SACC has knowledge regarding the presence of coverage in specific locations along the route via past learning experienced by the vehicles and various handsets that are part of this ecosystem. The system develops a map of which areas are covered best by particular PLMNs. Before the AV reaches an area where conditions dictate that connectivity needs to switch to another PLMN for best coverage, the SACC will communicate with the SDC to switch onto the desired PLMN once it crosses into a particular area.

In an embodiment, the SDC establishes dual connectivity to the core via the current PLMN and the future PLMN where the same data is sent in parallel until the signal of the current PLMN fades away and the dominant PLMN takes over completely. The connectivity to the current and/or future PLMN will be established using 3GPP standard flows for non-roaming and roaming use cases. Traffic coming from the SDC on a different carrier will be routed to the current/serving SACC - the roaming network will deliver the traffic to an Internet address for the SACC. The SACC is aware of duplicate concurrent streams and will cancel the more error prone stream.

In an embodiment, the network operator may provision an SSC mode selection policy (SSCMSP) for the SDC on the AV as part of the URSP rule. The SDC shall use the SSCMSP to determine the type of session and service continuity mode associated with an application or group of applications. A rule would contain the Slice Id, DNN and SSC mode for the session. SSC Mode 3 as described in 3GPP 23.501 and 23.502 would preferably be used. With SSC mode 3, the network ensures that the AV suffers no loss of connectivity. A connection through a new PDU session anchor point is established before the previous connection is terminated (make before break), as described above. The SACC will communicate the need to relocate the session to the current SMF based on factors such as latency or geographic location.

Then the system continues to track the AV in step 233. In an embodiment, the SACC uses an API to communicate vehicle location, possibly approximated by serving cell site location to backend servers. The backend servers may use location data to assign the session to the most desirable server. The SACC polls servers periodically for availability and may re-route sessions to a different backend server if it loses contact with the current server.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2C is a block diagram illustrating an example, non-limiting embodiment of a system for transient roaming and slicing for voice and text messaging functioning within the communication network of FIG. 1 in accordance with various aspects described herein. As further described below, the above-described transient roaming scheme for autonomous vehicles may be adapted to voice and text messaging services. As shown in FIG. 2C, system 240 comprises a handset (UE 241), a RAN 242 and core network elements comprising a home AMF 243, an IP multimedia subsystem/telephony application server (IMS/TAS 244) and a home UPF 245. In the embodiment depicted in FIG. 2C, the functionality of the SACC resides in UE 241 and communicates with the TAS of IMS/TAS 244. The method described above deviates from standard procedures that consider roaming as an over-the-top (OTT) application, instead of having the roaming process implemented as an infrastructure between network carriers, where the serving MME/AMF for the home network is the same mobility manager that controls the data flow. A visitor network AMF/MME directs the data traffic to the home AMF/MME. However, control signaling coming from the guest AMF/MME will be directed to the guest UDM/UDR, which will synchronize with the home network UDM/UDR to obtain records of the subscriber using UE 241.

Since the paradigm described above provides predictable network switching, the home UDM/UDR and visitor UDM/UDR can synchronize records for the subscriber in advance, so that when UE 241 needs to attach to the visitor network, the visitor network will already have the information ready in the guest UDM/UDR. The home authentication server function (AUSF) provides a token to the visitor AUSF, which in turn provides the same token to UE 241 as well. Once the UE reaches the visitor network, UE 241 presents the token and the visitor AUSF will match the token obtained from the home AUSF. If the tokens match, UE 241 will be authenticated on the visitor network. This method allows opportunistic temporary roaming (as opposed to traditional roaming where the whole call is hosted by a peer carrier). This method would allow only segments of the call to be served by a peering carrier for a higher quality of service.

Once UE 241 returns to the coverage area of the home MME/AMF, UE 241 can resume normal operation. And once the home carrier gets good coverage in this area/time, the call traffic flow shifts over to the home MME/AMF directly. With this method, the IMS core and TAS of the host carrier are bypassed. SMS will follow the same path as described above for voice and bypasses the service of the SMS application server in the visitor core network.

A new billing function in the AMF/MME tracks the amount of traffic received by a peering AMF/MME to provide billing and charges to the subscriber and pay for the carrier of the visitor network for this OTT roaming functionality. A link between the AMF and the charging function (CHF) accounts for roamed data in the billing record. Each user will pay extra charges for this OTT feature when it is enabled, and the PCF will flag the profile for UE 241 that the subscriber is willing to pay extra for this service.

In an embodiment, visitor networks can broadcast to UEs within their coverage area that there are good available resources for QoS (i.e., high bandwidth and low latency). If the UE is interested in the broadcasted QoS (because the UE either suffers from low QoS or because the UE needs more resources for certain applications), the UE can consult the PCF of the home network to see if the UE is permitted to shift the communications (i.e., the profile indicates the subscriber will pay for the service), and if permitted, the UE can temporarily move to the visitor network and attach, following the procedures discussed in this disclosure.

In an embodiment, the home network can present the UE (either through a pop-up notification or a SMS text) advertising the ability and cost. The user can accept or reject the offer. Also, users may create a background configuration that will automatically attach to better resources provided by visitor networks and agree to be charged for such services.

FIG. 2D is a block diagram illustrating an example, non-limiting embodiment of a system preparing for handover during transient roaming for voice and text messaging functioning within the communication network of FIG. 1 in accordance with various aspects described herein. As shown in FIG. 2D, when the home network has a good connection, a session connection proceeds from UE 241 through the RAN 242 to the home AMF 243 and the TAS 244 (in the case of a voice call), the home UPF 245 and onward to the Internet. If the wireless connection becomes poor, the home AMF 243 consults the home PCF (not shown) to see if carrier shifting is permitted. If so, then the home UDM/UDR 243a synchronizes records of the subscriber with the visitor UDM/UDR 253a. Next, the home AUSF 243b sends the UE a security token for a handover to the visitor AUSF 253b.

FIG. 2E is a block diagram illustrating an example, non-limiting embodiment of a handover during transient roaming for voice and text messaging functioning within the communication network of FIG. 1 in accordance with various aspects described herein. As shown in FIG. 2E, the handover begins when the home AMF 243 instructs UE 241 to attach to the visitor PLMN belonging to the host carrier. UE 241 authenticates with the visitor AUSF 253b using the security token through the visitor RAN 252, and then sets up a session through the visitor AMF 253, enabling communications through the visitor IMS/TAS 254 and the visitor UPF 255 to the Internet. Alternatively, the UE can connect to the Internet through the home AMF 243. For example, if UE 241 is connecting to a local sever/device, then the connection can come back to the home AMF 243. If the session is going outbound over Internet or another UE (in case of voice), then the connection can be sent to the UPF that is closest to the Internet destination, which can be either the home UPF 245 or the visitor UPF 255. The visitor AMF 253 will monitor and charge for data transferred while transient roaming.

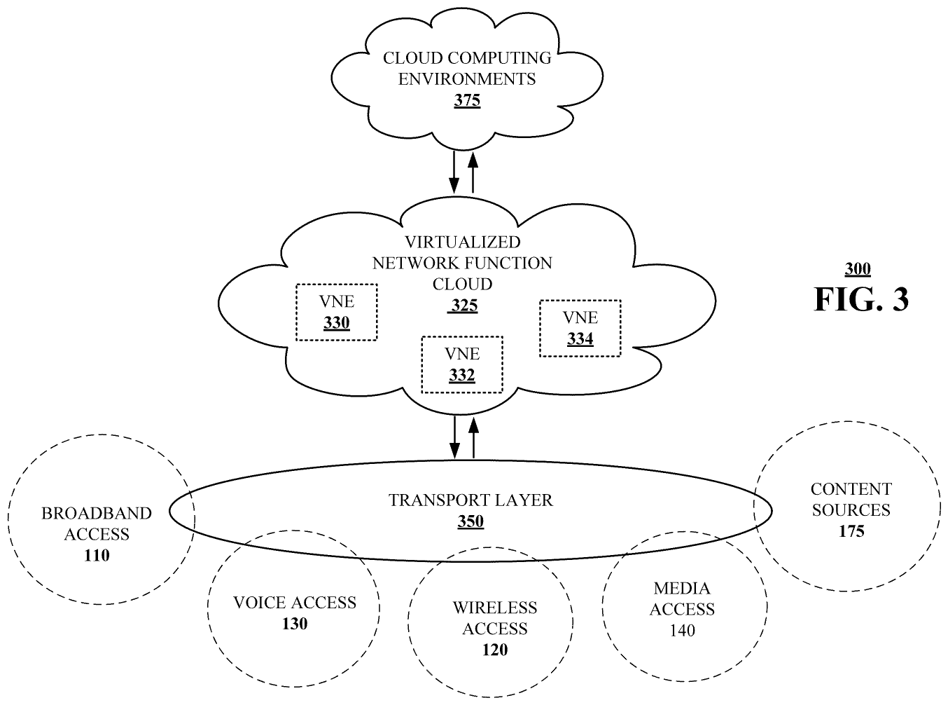

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems 200, 240, and method 230 presented in FIGS. 1, 2A, 2B, 2C, 2D, 2E and 3. For example, virtualized communication network 300 can facilitate in whole or in part predicting a travel path for a mobile device; identifying network(s) that can provide communication services along the predicted path; synchronizing communication requirements of application(s) on the mobile device; and establishing a communication session between the mobile device and new network(s).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

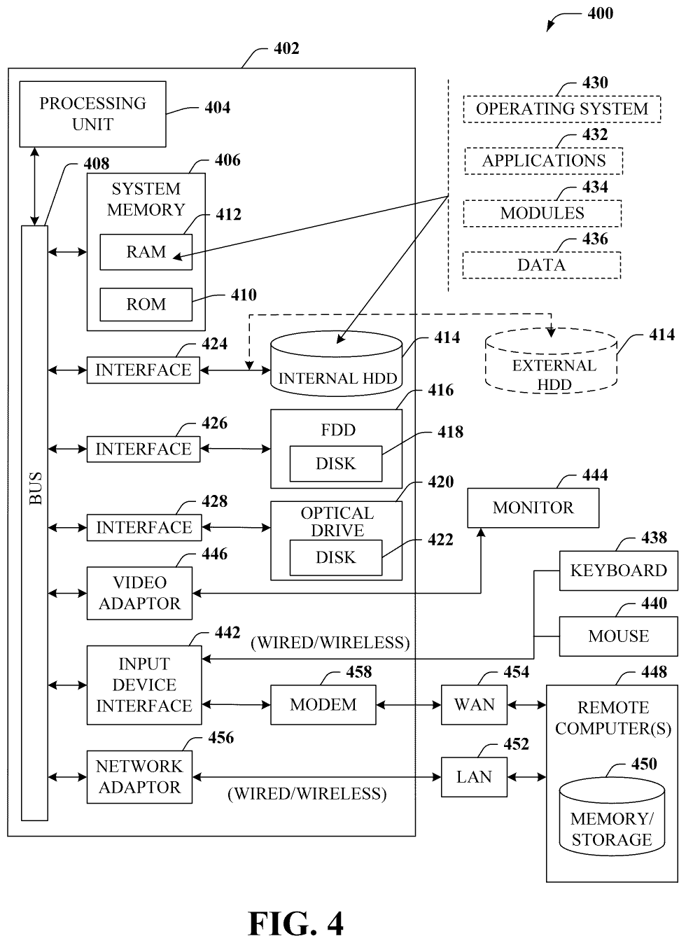

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part predicting a travel path for a mobile device; identifying network(s) that can provide communication services along the predicted path; synchronizing communication requirements of application(s) on the mobile device; and establishing a communication session between the mobile device and new network(s).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can also be connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

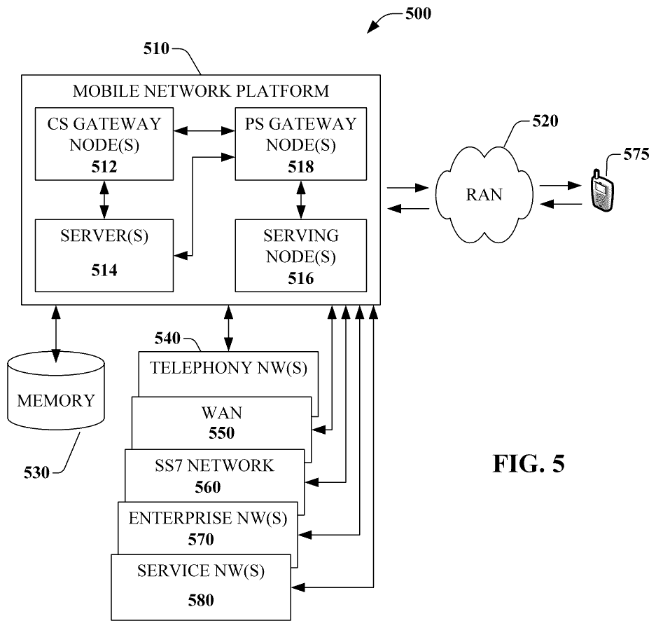

Turning now to FIG. 5, an embodiment of a mobile network platform 510 is shown that is an example of network elements 150, 152, 154, 156, and/or VNEs 330, 332, 334, etc. For example, platform 510 can facilitate in whole or in part predicting a travel path for a mobile device; identifying network(s) that can provide communication services along the predicted path; synchronizing communication requirements of application(s) on the mobile device; and establishing a communication session between the mobile device and new network(s). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

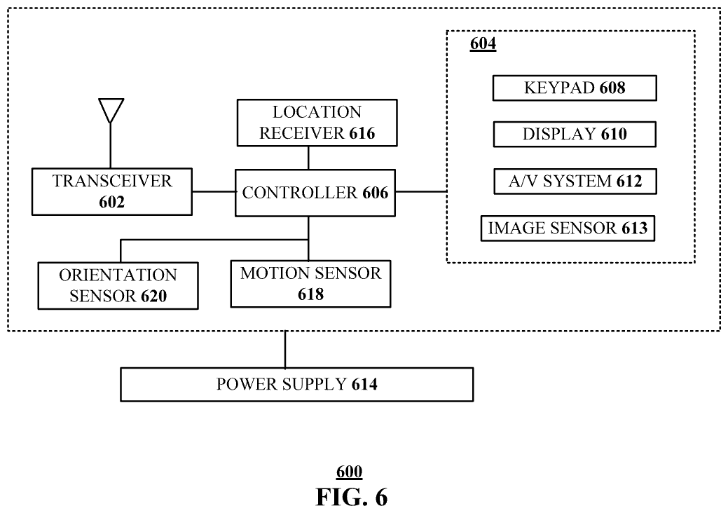

Turning now to FIG. 6, an illustrative embodiment of a communication device 600 is shown. The communication device 600 can serve as an illustrative embodiment of devices such as data terminals 114, mobile devices 124, AV 126, display devices 144 or other client devices for communication via either communications network 125. For example, computing device 600 can facilitate in whole or in part predicting a travel path for a mobile device; identifying network(s) that can provide communication services along the predicted path; synchronizing communication requirements of application(s) on the mobile device; and establishing a communication session between the mobile device and new network(s).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals from an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, and opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
determining a predicted path of travel of a mobile device using a first network for data communications;
identifying a second network providing communication services in an area that would be entered by the predicted path;
synchronizing communication requirements of a communication session of an application on the mobile device with the second network; and
establishing the communication session between the mobile device and the second network for the application.

2. The device of claim 1, wherein the communication requirements include low latency, bandwidth, priority, high reliability, or a combination thereof.

3. The device of claim 1, wherein the communication requirements include a slice identifier, a data network name, a session and service continuity mode for the session, or a combination thereof.

4. The device of claim 1, wherein the communication session is supported by a network slice that guarantees a quality of service meeting the communication requirements.

5. The device of claim 1, wherein the mobile device is an autonomous vehicle.

6. The device of claim 5, wherein the first network comprises a profile for the autonomous vehicle that includes: vehicle structure, weight, top speed, age, acceleration, autonomous driver version, or a combination thereof.

7. The device of claim 1, wherein the second network comprises a wireless fidelity network.

8. The device of claim 1, wherein a policy control function of the first network biases a session management function of the first network to force a user plane function of the first network to handover the communication session from the first network to the second network.

9. The device of claim 1, wherein a first authentication server function of the first network provides a security token to the mobile device and to a second authentication server function of the second network for the second network to authenticate the mobile device.

10. The device of claim 1, wherein the predicted path of travel is determined using a profile for an environment of the mobile device, wherein the profile includes a geometry of a road in a particular segment, weather conditions, existing traffic conditions, predicted traffic conditions, or a combination thereof.

11. The device of claim 1, wherein the processing system uses artificial intelligence and machine learning to determine the predicted path of travel.

12. The device of claim 1, wherein the second network is identified using a profile for the second network, wherein the profile includes a priority, a network application type, congestion, predicted congestion, or a combination thereof.

13. The device of claim 1, wherein the processing system comprises a plurality of processors operating in a distributed computing environment.

14. A non-transitory machine-readable medium, comprising executable instructions that, when executed by a processing system including a processor, facilitate performance of operations, the operations comprising:
identifying a second network providing communication services in an area that a mobile device is predicted to enter, wherein the mobile device uses communication services from a first network for data communications;
sending communication requirements of a communication session of an application on the mobile device to core elements of the second network; and
establishing the communication session between the mobile device and the second network for the application.

15. The non-transitory machine-readable medium of claim 14, wherein the communication requirements include low latency, bandwidth, priority, high reliability, or a combination thereof.

16. The non-transitory machine-readable medium of claim 14, wherein the communication session is supported by a network slice that guarantees a quality of service meeting the communication requirements.

17. The non-transitory machine-readable medium of claim 16, wherein the communication requirements include a slice identifier, a data network name, a session and service continuity mode for the session, or a combination thereof.

18. The non-transitory machine-readable medium of claim 14, wherein a policy control function of the first network biases a session management function of the first network to force a user plane function of the first network to handover the communication session from the first network to the second network.

19. The non-transitory machine-readable medium of claim 14, wherein the processing system comprises a plurality of processors operating in a distributed computing environment.

20. A method, comprising:
identifying, by a processing system including a processor, a second network providing communication services in an area that a mobile device using the communication services of a first network is predicted to enter;
synchronizing, by the processing system, communication requirements of a communication session for an application on the mobile device between core elements of the first network and the second network, wherein the core elements include a policy control function, a session management function and a user plane function, wherein the communication requirements include a slice identifier, a data network name, a session and service continuity mode for the session, or a combination thereof; and
requesting, by the processing system, the second network to establish the communication session between the mobile device and the second network for the application.
